(19) United States
(12) Patent Application Publication
(10) Pub. No.: US 2015/0234983 A1
(43) Pub. Date: Aug. 20, 2015

(54) METHOD AND SYSTEM FOR RETURNING PATIENT TEST RESULTS

(71) Applicant: University of Washington through its Center for Commercialization, Seattle, WA (US)

(72) Inventors: Holly Tabor, Seattle, WA (US); Michael J. Bamshad, Seattle, WA (US); Joon-Ho Yu, Seattle, WA (US)

(21) Appl. No.: 14/422,429

(22) PCT Filed: Aug. 23, 2013
(86) PCT No.: PCT/US2013/056445

§ 371 Date: Feb. 19, 2015

Related U.S. Application Data
(60) Provisional application No. 61/692,646, filed on Aug. 23, 2012.

(51) Int. Cl. G06F 19/00

(52) U.S. Cl. CPC G06F 19/322

(57) ABSTRACT

Example systems and methods are provided for returning patient genome or exome sequencing results. In one example, a test database including data indicating one or more subjects and a plurality of test results may be maintained. Each subject may be associated with one or more respective test result from the plurality of test results. Returning patient genome or exome sequencing results from the database may involve receiving subject data identifying a particular subject in the test database, identifying at least one respective test result associated with the particular subject, causing at least one visual indication corresponding to the identified at least one respective test result to be provided on a display, receiving selection data, receiving access data, and causing a visual indication of the selected one or more of the identified at least one respective test result to be provided on the display in response to receiving the access data.

### CROSS-REFERENCE TO RELATED APPLICATION

This application claims the benefit of U.S. Provisional Application No. 61/692,646, filed Aug. 23, 2012, which is incorporated herein by reference in its entirety.

### BACKGROUND

Whole genome sequencing is a process for determining a complete DNA sequence of an organism's genome. This process may involve sequencing all of the chromosomal DNA and the mitochondrial (or chloroplast) DNA of the organism. In some cases, a single biological sample from the organism may contain a full copy the organism's DNA, and may therefore be sufficient for full genome sequencing. Such samples may include, for example, saliva, epithelial cells, bone marrow, hair follicles, seeds, and plant leaves, among other examples.

The amount of DNA sequence data produced from whole genome processing may be quite large. For instance, there are approximately six billion base pairs in each human diploid genome. As such, the computing power and data storage requirements necessary for whole genome sequencing may be quite large.

Exome sequencing, also known as targeted exome capture, involves selectively sequencing the coding regions of the genome. Exons are generally short, functionally important sequences of DNA which represent the regions in genes that are translated into protein and the un-translated regions flanking them. There are approximately 180,000 exons in the human genome, and those exons constitute only about 1% of the human genome. Nevertheless, the protein coding regions of the human genome (i.e., those regions targeted by exome capture) have been estimated to constitute about 85% of disease-causing mutations. As such, the computing power and data storage requirements necessary for exome sequencing may be considerably less than that necessary for whole genome sequencing. Accordingly, exome sequencing may provide a less expensive but still effective alternative to whole genome sequencing, especially for purposes of detecting disease-causing mutations.

Test results, whether from whole genome sequencing, exome sequencing, or other health and medical related tests such as blood tests, may be complicated and/or sensitive. The results are often sent from a laboratory, where analysis of a patient's test sample may have been performed, to a medical practitioner of the patient. According to some procedures, the medical practitioner may review the test results, and the patient and/or parents of the patient and the medical practitioner may subsequently schedule a time to meet and discuss the results. This process, however, may be tedious and inefficient due to, for example, potential scheduling conflicts between the two parties involved and potentially limited time and attention available from either party. As such, systems and methods for helping improve the return of test results to a patient and/or other authorized individuals may be beneficial.

### SUMMARY

In one aspect, a computer implemented method is provided. The method includes maintaining a test database including data that indicates (a) one or more subjects and (b) a plurality of test results. Each subject is associated with one or more respective test result from the plurality of test results. The method also includes receiving subject data that identifies a particular subject in the test database, identifying at least one respective test result associated with the particular subject, causing at least one visual indication corresponding to the identified at least one respective test result to be provided on a display, and receiving selection data. The selection data indicates a selection of one or more of the identified at least one respective test result via a selection of one or more of the at least one visual indication corresponding to the identified at least one test result. The method also includes receiving access data. The access data indicates a result-access credential for accessing the selected one or more of the identified at least one respective test result. The method also includes, in response to receiving the access data, causing a visual indication of the selected one or more of the identified at least one respective test result to be provided on the display.

In another aspect, a system is provided. The system includes a processor, a physical computer readable medium, and program instructions stored on the physical computer readable medium. The program instructions are executable by the processor to maintain a test database including data that indicates (a) one or more subjects and (b) a plurality of test results. Each subject is associated with one or more respective test result from the plurality of test results. The program instructions are also executable by the processor to receive subject data that identifies a particular subject in the test database, identify at least one respective test result associated with the particular subject, cause at least one visual indication corresponding to the identified at least one respective test result to be provided on a display, and receive selection data. The selection data indicates a selection of one or more of the identified at least one respective test result via a selection of one or more of the at least one visual indication corresponding to the identified at least one test result. The program instructions are also executable by the processor to receive access data. The access data indicates a result-access credential for accessing the selected one or more of the identified at least one respective test result. The program instructions are also executable by the processor to cause a visual indication of the selected one or more of the identified at least one respective test result to be provided on the display in response to receiving the access data.

In yet another aspect, a physical computer readable medium having instructions stored thereon is provided. The instructions include instructions for maintaining a test database including data that indicates (a) one or more subjects and (b) a plurality of test results. Each subject is associated with one or more respective test result from the plurality of test results. The instructions also include instructions for receiving subject data that identifies a particular subject in the test database, instructions for identifying at least one respective test result associated with the particular subject, instructions for causing at least one visual indication corresponding to the identified at least one respective test result to be provided on a display, and instructions for receiving selection data. The selection data indicates a selection of one or more of the identified at least one respective test result via a selection of one or more of the at least one visual indication corresponding to the identified at least one test result. The instructions also include instructions for receiving access data. The access data indicates a result-access credential for accessing the selected one or more of the identified at least one respective test result. The instructions also includes instructions for causing a visual indication of the selected one or more of the identified at least one respective test result to be provided on the display in response to receiving the access data.

### BRIEF DESCRIPTION OF THE DRAWINGS

FIG. 1 shows a flowchart depicting an example embodiment for returning patient test results, in accordance with an example embodiment.

FIGS. 2A-2L each show aspects of an example interface for returning patient test results, in accordance with an example embodiment.

FIGS. 3A-3L each show aspects of an example interface for returning patient test results, in accordance with an example embodiment.

FIG. 4 shows a physical computer-readable medium, in accordance with an example embodiment.

FIG. 5 shows a simplified block diagram of an example communication network in which the present methods can be implemented.

FIG. 6 shows a simplified block diagram of a network-access device arranged to implement aspects of at least one example embodiment of the methods.

FIG. 7 shows a simplified block diagram of a server arranged to implement aspects of at least one example embodiment of the methods.

### DETAILED DESCRIPTION

The present application is directed to returning patient test results, such as patient genome or exome sequencing results. While the example embodiments described herein may relate particularly to returning patient genome or exome sequencing results, one having ordinary skill in the art will appreciate that the systems and methods disclosed in relation to the example embodiments may be implemented for a variety of different applications. The variety of different applications may include the return of other patient health and medical test results, or general academic or certification test results.

Whether the test results indicate medical conditions or any other information, the test results may be both complicated and sensitive. As such, a suitable system and/or method may be provided for returning the test results in an efficient, secure, and meaningful way.

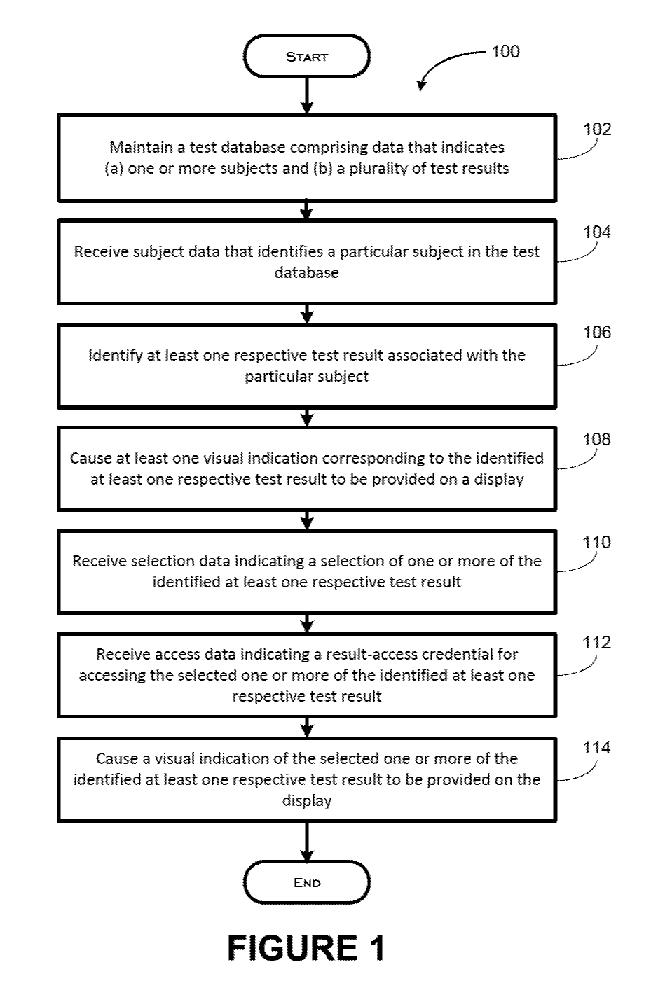

FIG. 1 is a flowchart depicting an example embodiment for returning patient test results, in accordance with at least some embodiments described herein. Method 100 shown in FIG. 1 may include one or more operations, functions, or actions as illustrated by one or more of blocks 102-114. As shown, block 102 of the method 200 generally relate to maintaining a test database of data indicating test subjects and corresponding test results, blocks 104-106 generally relate to determining test results accessible by a user, blocks 108-112 generally relate to selection of test results a user may desire to view, and block 114 generally relates to providing the test results to the user. Although the blocks are illustrated in sequential order, these functions associated with these blocks may also be performed in parallel, and/or in a different order than those described herein. Also, the various blocks may be combined into fewer blocks, divided into additional blocks, and/or removed based upon the desired implementation.

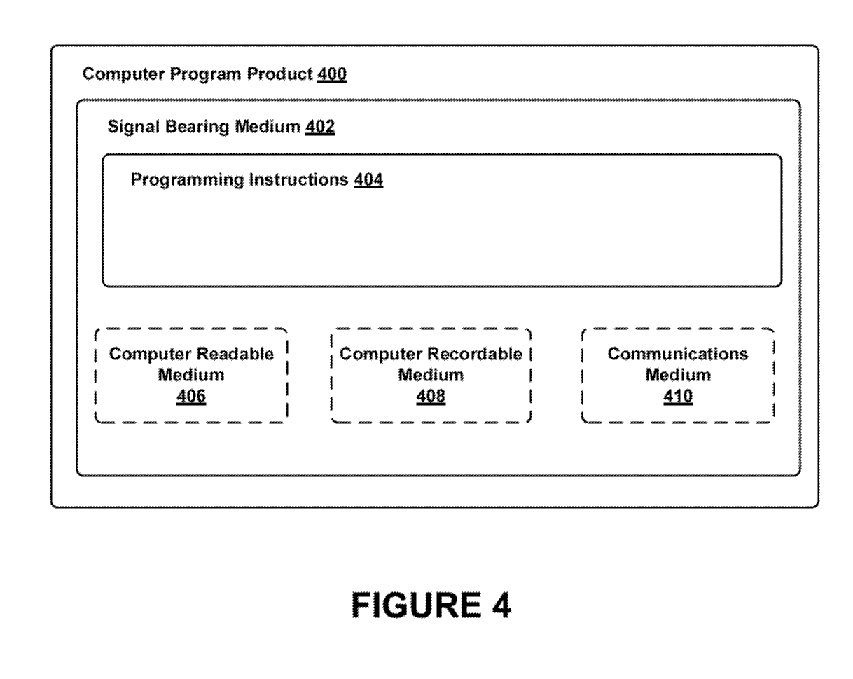

In addition, for the method 100 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. As will be further discussed below in connection to FIG. 4, the program code may be stored on any type of computer readable medium, for example, such as a storage device including a disk or hard drive. The computer readable medium may include physical and/or non-transitory computer readable medium, for example, such as computer-readable media that stores data for short periods of time like register memory, processor cache and Random Access Memory (RAM). The computer readable medium may also include physical and/or non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the method 100 and other processes and methods disclosed herein, each block in FIG. 1 may represent circuitry that is wired to perform the specific logical functions in the process.

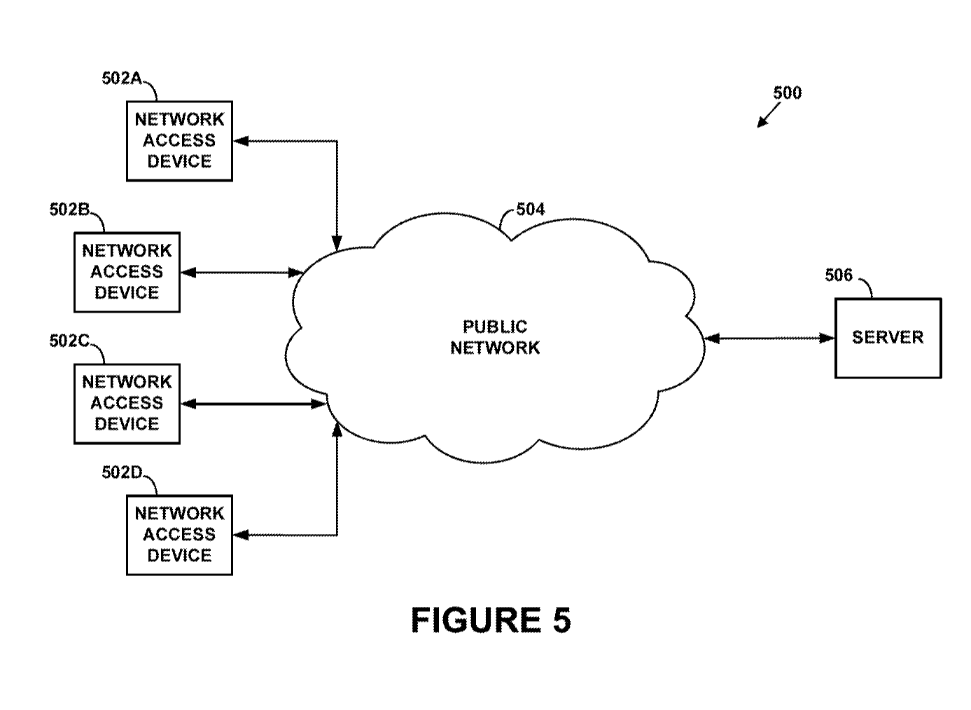

Further, as will be further discussed below in connection to FIGS. 5-7, the method 100 and other processes disclosed herein may be carried out by a computing system in a network, e.g. in communication with a network, or locally. The computing system may include one or more of a personal computer, a laptop computer, a tablet computer, a cellular phone, or any type of user interface-capable device.

As shown, block 102 may involve maintaining a test database including data that indicates (a) one or more subjects and (b) a plurality of test results. In one case, each subject may be associated with one or more respective test result from the plurality of test results. As suggested above, the one or more respective test results may be genome sequencing results, exome sequencing results, other types of medical test results, or general academic or certification test results. In some cases, patient genome or exome sequencing may be ordered for patients that may have a genetic condition. As such, the one or more respective test result associated with a particular subject may indicate one or more genetic conditions of the particular subject.

Prior to or as part of maintaining the test database as discussed in connection to block 102, the one or more respective test result associated with the particular subject may be received at the test database as test-result data indicating at least one of the one or more respective test results associated with the particular subject. The test-result data may be received at the test database from laboratory where analysis of a sample of the particular subject was performed. In one case, the test-result data may be received over a network, such as the internet or a local access network. In another case, the test-result data may be received locally via input into a computing system coupled to the test database. In one example, the test-result data may be automatically received at the test database once the test-result data is available from the laboratory. In another example, the test-result data may be reviewed and annotated by a medical practitioner before being received at the test database.

In one example, the received test-result data may include (a) an identification of the particular subject and (b) annotated variant data generated based on a test performed on the particular subject. In one example, the annotated variant data may indicate biological information that has been identified within the sequenced genome or exome of the particular subject. In some cases, a genome or exome sequencing process performed on the particular subject may produce raw genome or exome sequence data. In this case, the raw or exome genome sequence data may be further processed and annotated to identify biological information represented within the genome or exome sequence data, producing the annotated variant data.

Upon receiving the test-result data, a result-access credential for accessing the at least one test result may be generated based on the identification of the particular subject included with the test-result data. In one case, the result-access credential may be unique to the particular subject. In another case, the result-access credential may be unique to the specific at least one test result for the particular subject. In other words, the result-access credential provides credentials at least unique to the particular subject, and in some cases unique to the specific at least one test result. Ultimately, only users of the test database with the result-access credential may access the at least one test result for the particular subject. In one case, the result-access credential may be generated and provided to the particular subject such that particular subject can access the at least one test result. In another case, the result-access credential may be generated and provided to immediate family members or caretakers of the particular subject such that they may access the at least one test result.

In one example, the result-access credential may be in the form of a textual access code. In one case, a single textual access code may be generated for any user authorized to access the at least one test result. In another case, different textual access codes may be generated for different users authorized to access the at least one test result. In some cases, different textual access codes may grant different degrees of access to the at least one test result.

After generating the result-access credential, the received test-result data may be stored in the test database as part of maintaining the test database. In some cases, the generated result-access credential may also be stored in the test database along with the corresponding test-result data. In some other cases, the generated result-access credential may be stored in a separate database associated with the test database.

As mentioned, only users of the test database with result-access credential for the at least one test result may access the at least one test result for the particular subject. In one example, a user may be required to set up an account to access the test database. Setting up the account may involve receiving from the user user-identification data indicating a database-access credential for accessing the test database. In one case, the user may setup an account to access the test database via a user interface or network interface, such as web browser on a computer in communication with the test database. In one instance, the computer may be connected to the Internet and may access the test database over the World Wide Web. In another instance, the computer may be locally connected to the test database, such as over a local area network. As suggested above, the user-identification data may be associated with the identification of the particular subject. In some cases, a single user of the test database may be associated with more than one particular subject. For instance, the user may be a parent of children, each of who are subjects of genome or exome sequencing, and the parent may therefore be associated with each child.

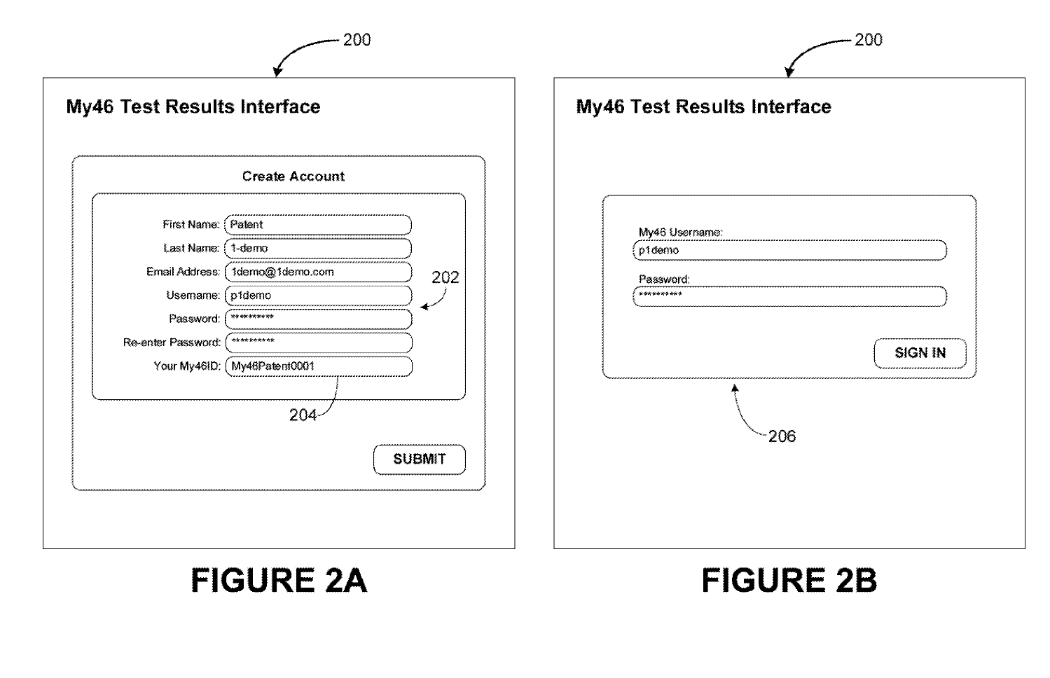

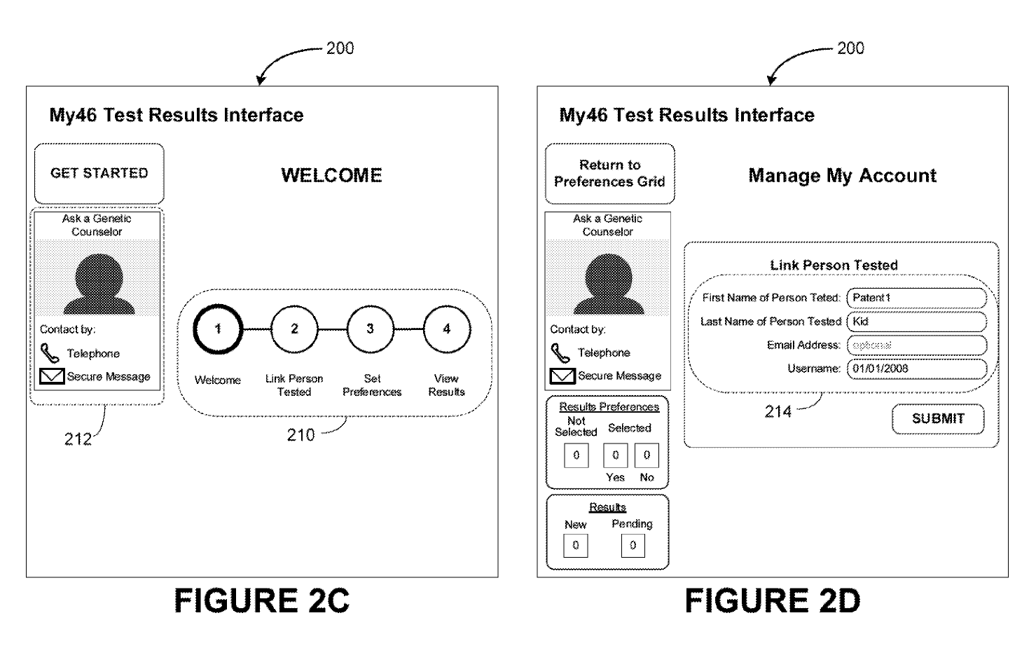

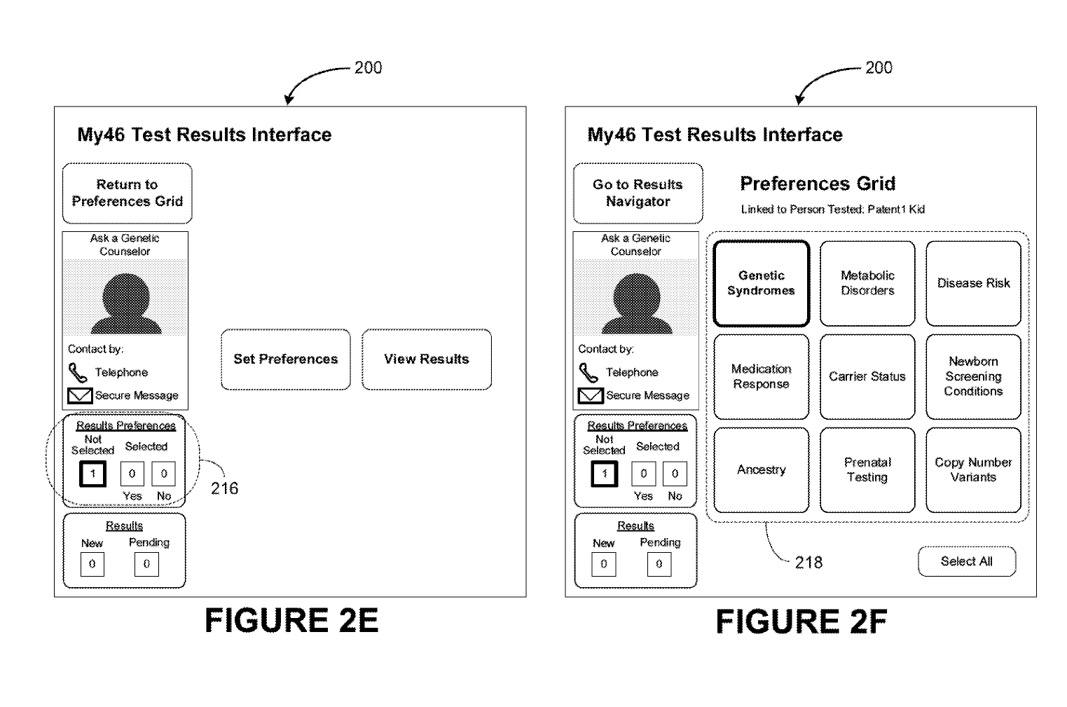

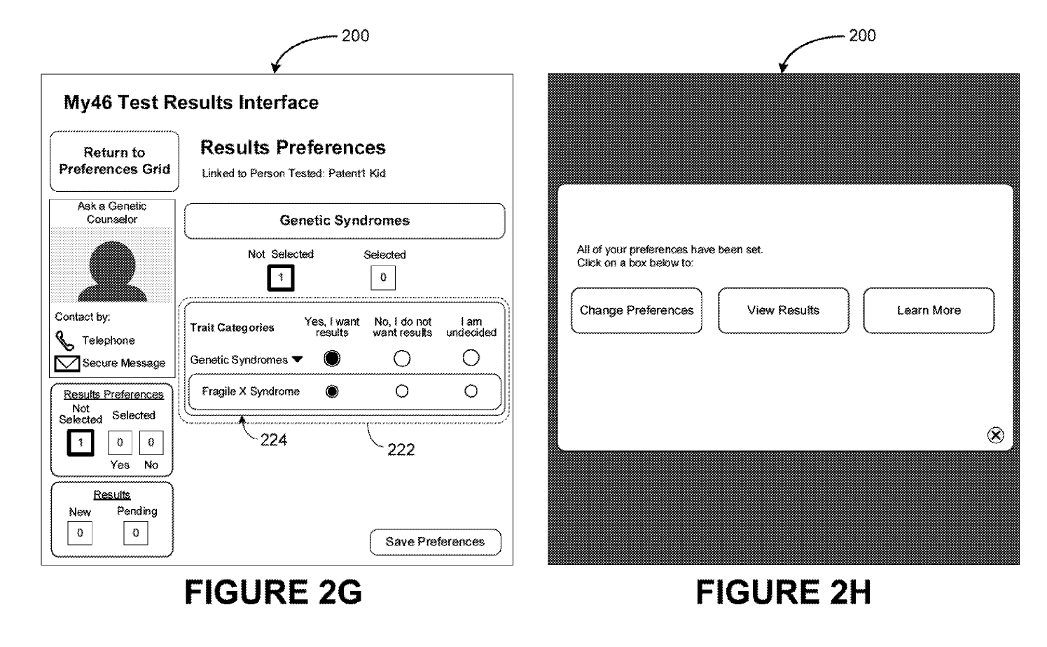

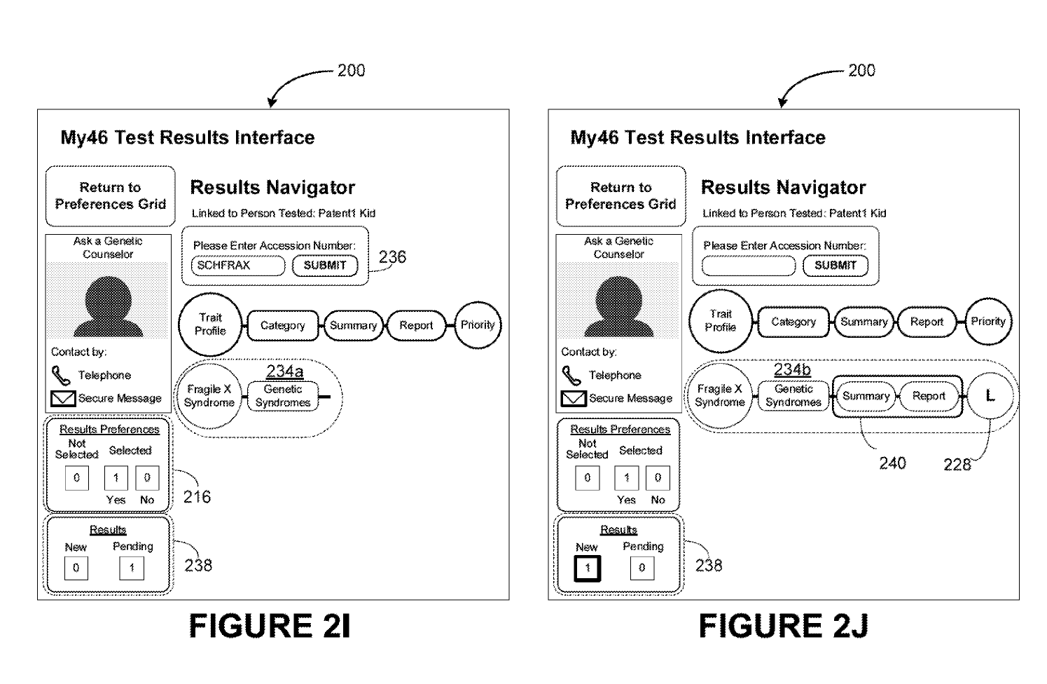

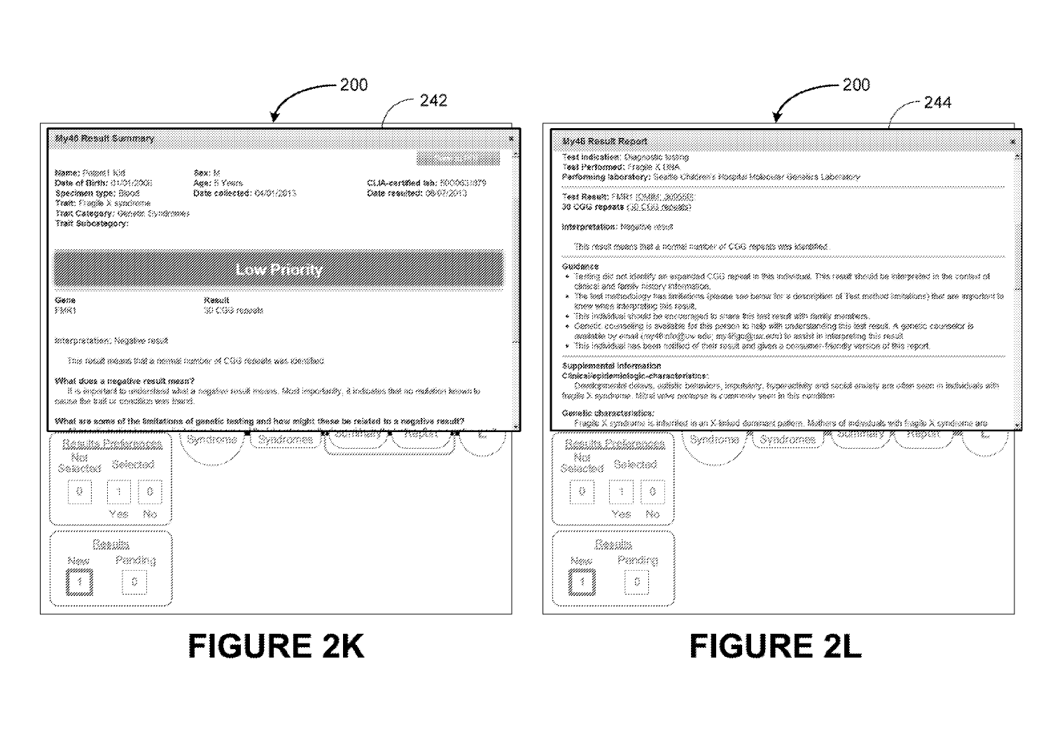

Block 104 of the method 100 may involve receiving subject data that identifies a particular subject in the test database. In this case, the user of the test database may provide the subject data when accessing the test database to indicate the particular subject for which the user wishes to access the test results. In one example, the subject data may be received from the user when the user is setting up an account to access the test database. FIG. 2A shows an example interface 200 through which the user may setup an account, provide the subject data, and subsequently access the test database. In other words, the interface 200 as shown in FIG. 2A may be provided such that the subject data identifying the particular subject in the test database may be received, as described in connection to block 104.

The interface 200 may be provided on a display, which in some cases may be a touch-sensitive display. The display may be configured to provide access to the test database via the interface 200. In this instance, the interface 200 as shown in FIG. 2A provides a “Create Account” box for receiving user-identification data 202 when the user sets up the account to access the test database. As shown, first and last names, an email address, a username and a password may be received to set up the account. In addition to the user-identification data 202, the “Create Account” box may also receive subject data 204 for linking or associating the particular subject with the account being setup. Upon entering the necessary information, the user account may be setup and the user may be automatically logged in to access the test database.

In another case, as shown in FIG. 2B, the example interface 200 may provide a login prompt 206 for the user to login if an account has already been set up. In this case, if the subject data was already received when the user account was setup, as discussed above, the user may not be prompted to provide the subject data again. In another case, which is not shown, the login prompt 206 may require the subject data to be provided each time the user attempts to login to access the test database.

Block 106 of the method 100 may involve identifying at least one respective test result associated with the particular subject. After logging on to access the test database via the interface 200 shown in FIGS. 2A or 2B, the interface 200 may provide for display information on how to start accessing the at least one test result associated with the subject data provided. As shown in FIG. 2C, the interface 200 may include a genetic counselor contact section 212 providing means to contact a genetic counselor if the user has any questions at any time. Further, a flow diagram 210 indicates steps for accessing test results in the test database. As shown in FIG. 2C, the interface 200 may provide a “Get Started” icon selectable to proceed with accessing test results.

As indicated above, subject data identifying the particular subject may have been provided when the user set up the account to access the database. Accordingly, identifying the at least one respective test result associated with the particular subject may be based on at least the user-identification data provided when setting up the account. As discussed above, the user-identification data may be associated with the identification of the particular subject. As such, test results associated with the particular subject may be identified through an identification of the particular subject associated with the user-identification data. In other words, in the case the user is a parent wishing to access the test database to view test results for a child, the test results for the child may be identified at least partially based on the identification of the parent, and data in the test database indicating the relationship between the parent and the child.

In some cases, to more discriminately identify the at least one respective test result associated with the particular subject that the user wishes to access, additional information may be received from the user to identify the particular subject. For instance, as shown in the interface 200 of FIG. 2D, a “Link Person Tested” box may be provided to receive additional information identifying the particular subject. In this example, the “Link Person Tested” box may be configured to receive information such as a first name, last name, and date of birth of the particular subject. In addition, an optional medical record number, if available, may be provided to further identify the particular subject. As shown in FIG. 2D, a “Submit” icon may be selectable to submit the entered information and proceed to access the identified at least one respective test result.

Upon selection of the “Submit” icon, the interface 200 as shown in FIG. 2E may provide a “Results Preference” section 216 indicating that one non-selected test result is available for the identified particular subject. The interface 200 may further provide a “Set Preferences” icon selectable to proceed with setting preferences for viewing the at least one respective test result associated with the particular subject, which in this case is the one non-selected test result. Upon selection of the “Set Preferences” icon, the interface 200 may provide preference setting options as shown in FIG. 2F.

Referring back to the method 100 of FIG. 1, block 108 may involve causing at least one visual indication corresponding to the identified at least one respective test result to be provided on a display. In some cases, the identified at least one respective test result may be organized according to a category of the test. Accordingly, block 108 may further involve determining at least one result category associated with the identified at least one respective test result, and causing at least one visual indication corresponding to the at least one determined result category to be provided on the display.

As shown in FIG. 2F, causing the at least one visual indication corresponding to the at least one determined result category to be provided on a display may involve the interface 200 providing a result categories grid 218 showing a plurality of result category tiles. In this case, a “Genetic Syndromes” category tile may be highlighted (in this case, with accentuated borders) to indicate the identified at least one respective test result has been categorized under a “Genetics Syndromes” category. In some cases, as will be shown in examples below, a single test result may be categorized under multiple categories.

In this example, the highlighted “Genetic Syndromes” category tile may further indicate that preferences for viewing the identified at least one respective test result may be set by selecting the “Genetic Syndromes” category tile. Accordingly, category-selection data indicating a selection of one or more of the at least one determined result category may be received via a selection of one or more of the at least one visual indication corresponding to the at least one determined result category. As mentioned above, the selected one or more of the at least one determined results category may be associated with the identified at least one respective test result.

Upon selection of the “Genetic Syndromes” category style, the interface 200 may provide the at least one visual indication corresponding to the identified at least one respective test result, as shown in FIG. 2G. In this case, as shown, the interface 200 may provide a result-viewing selection box 222 including selectable options 224 corresponding to the identified at least one respective test result. As shown in this case, the identified at least one respective test result may be a test result for “fragile x syndrome.” In one example that is not shown, a visual indication of the “fragile x syndrome” test results may be selectable to cause selectable option for viewing the “fragile x syndrome” test results to be displayed. In some cases, the at least one visual indication the identified at least one respective test result may be organized by alphabetical order of a name of the identified at least one respective test result, or by the category or subcategory of the identified at least one respective test result. Other examples of visual indications may also exist.

Referring back to the method 100 of FIG. 1, block 110 may involve receiving selection data indicating a selection of one or more of the identified at least one respective test result. In one example, the selection data may be received via a selection of one or more of the at least one visual indication corresponding to the identified at least one test result. As shown in FIG. 2G, the received selection data may indicate as selection of “YES, I want results” for the “fragile x syndrome” test results. Subsequently, a selection of a “Save preferences” icon on the interface 200 may cause selection-preference data indicating the selection of the one or more of the identified at least one respective test result, which in this case may be the result for “fragile x syndrome,” to be stored in the test database. In one example, the selection-preference data may be associated with the user-identification data of the user to accessing the test database. As such, the result-viewing preferences for “fragile x syndrome” test results may be retained for when the user logs on to access the test database at a later time.

Tests relating to genetic conditions or the human genome or exome in general may be complicated and daunting to some users. As such, in some cases, the selection-preference data may be received through a less explicit manner than that shown in FIG. 2G. For instance, surveys configured to guide a user through setting result viewing preferences may be provided to help the user select results for viewing that best suits the user's needs.

Upon selection of the “Save preferences” icon, the interface 200 may provide a “Change Preferences” icon, a “View Results” icon, and/or a “Learn More” icon as shown in FIG. 2H. Selection of the “Change Preferences” icon may bring the user back to the interface 200 as shown in FIG. 2F, and selection of the “Learn More” icon may bring the user to a different interface that offers the user access to information on genetic testing, genome or exome sequencing, and the test database, etc.

Upon receiving the selection data as described in connection to block 110, block 112 of the method 100 may involve receiving access data indicating the result-access credential for accessing the selected one or more of the identified at least one respective test result Selection of the “View Results” icon provided by the interface 200 shown in FIG. 2H may cause the interface 200 as shown in FIG. 21 to provide a partial visual indication 234a of the selected one or more of the identified at least one respective test result, which is in this case is the “fragile x syndrome” test result. In this case, the partial visual indication 234a only identifies the test results and category of the test results without providing further information. The interface 200 as shown in FIG. 21 may further provide the Results Preference section 216 indicating that one of the identified at least one test result has been selected, and a Results section 238 indicating that viewing of the selected one of the at least one test result is pending.

The partial visual indication 234a and the Results section 238 indicating that viewing of the selected one of the at least one test result is pending may be because a result-access credential as discussed above may be required for viewing the selected one or more of the identified at least one test result. In other words, access data indicating the result-access credential for accessing the selected one or more of the identified at least one respective test result may be required.

In one example, in response to receiving the selection data indicating a selection of one or more of the identified at least one respective test result and/or receiving the selection of the “View Results” icon shown in FIG. 2H, access requirements such as the previously generated result-access credential for the selected one or more of the identified at least one respective test result may be determined In one case, determining the access requirements for the selected one or more of the identified at least one respective test result may involve retrieving the result-access credential associated with the selected one or more of the identified at least one respective test result from the test database or a separate database associated the test database where the generated result-access credential was stored.

As shown in FIG. 21, the interface 200 may further provide a visual indication of a prompt 236 to be provided on the display. The prompt 236 may request access data indicating the result-access credential to access the selected one or more of the identified at least one respective test result. As previously indicated, the result-access credential may be in the form of a textual access code. As shown in FIG. 21, access data indicating the result-access credential in the form of a textual access code may be provided to the prompt 236.

In response to receiving the access data upon a selection of a “Submit” icon in the prompt 236 to submit the entered textual access code and subsequently matching the submitted access data with the previously generated, stored, and retrieved result-access credential, block 114 may involve causing a visual indication of the selected one or more of the identified at least one respective test result to be provided on the display. The interface 200 of FIG. 2J shows a full visual indication 234b of the selected one or more of the identified at least one respective test result, which in this case is the “fragile x syndrome” test result. As shown, the full visual indication 234b includes selectable “Summary” and “Report” icons for viewing a summary and a report, respectively, for the “fragile x syndrome” test result.

The full visual indication 234b further includes an importance indicator 228 indicating an inferred degree of impact of the identified at least one respective test result on a well-being of the particular subject. In one example, if the test result for a specific genetic condition is negative, then the inferred degree of impact on the well-being of the particular subject may be low, and the importance indicator 228 may indicate as such. As shown in FIG. 2J, the inferred impact of the “fragile x syndrome” test results is low, and the importance indicator 228 indicates so. Also as shown in FIG. 2J, the Results section 238 has been updated to indicate that new test results are available, and that no test results are pending.

The interface 200 of FIG. 2K provides an example summary 242 displayed if the “Summary” icon of FIG. 2J is selected, and the interface 200 of FIG. 2L provides an example report 244 displayed if the “Report” icon of FIG. 2J is selected.12. As shown, the result of the “fragile x syndrome” test is negative, hence the inferred low impact on the well-being of the particular subject. In general, the summary 242 and/or the report 244 may provide information indicating (a) a description of the genetic condition, (b) symptoms of the genetic condition, (c) health risks relating to the genetic condition, and (d) available options for managing the genetic condition. Other examples are also possible. In the context of block 114, the visual indication of the selected one or more of the identified at least one respective test result may refer to either or both of the full visual indication 234b provided by the interface 200 in FIG. 21 or the summary 242 and report 244 provided by the interface 200 in FIGS. 2K and 2L, respectively.

In one example, the visual indication of the selected one or more of the identified at least one respective test result may be selected based on the annotated variant data in the test result data, previously provided as discussed in connection to block 102. In other words, content of the summary 242 and/or report 244 may be compiled based on the annotated variant data associated with the “fragile x syndrome” test results. In one example, different content may be previously prepared for each available genetic test at each inferred level of impact and subsequently provided to a user based on the test result and inferred level of impact for the particular subject.

As indicated by the interface 200 in FIGS. 2J-L, the result of the “fragile x syndrome” test is negative for the particular subject. In one example, additional genetic tests may have been ordered for the particular subject and updated test results may subsequently be available. In one example, the user may receive a phone call or email informing the user that new test results are available in the test database.

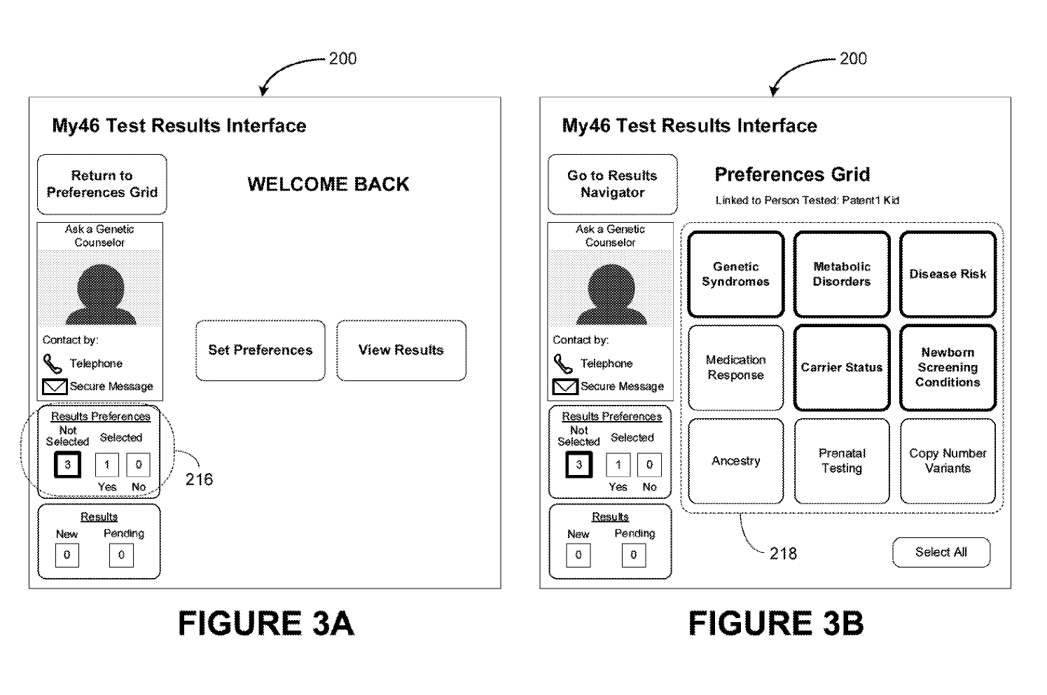

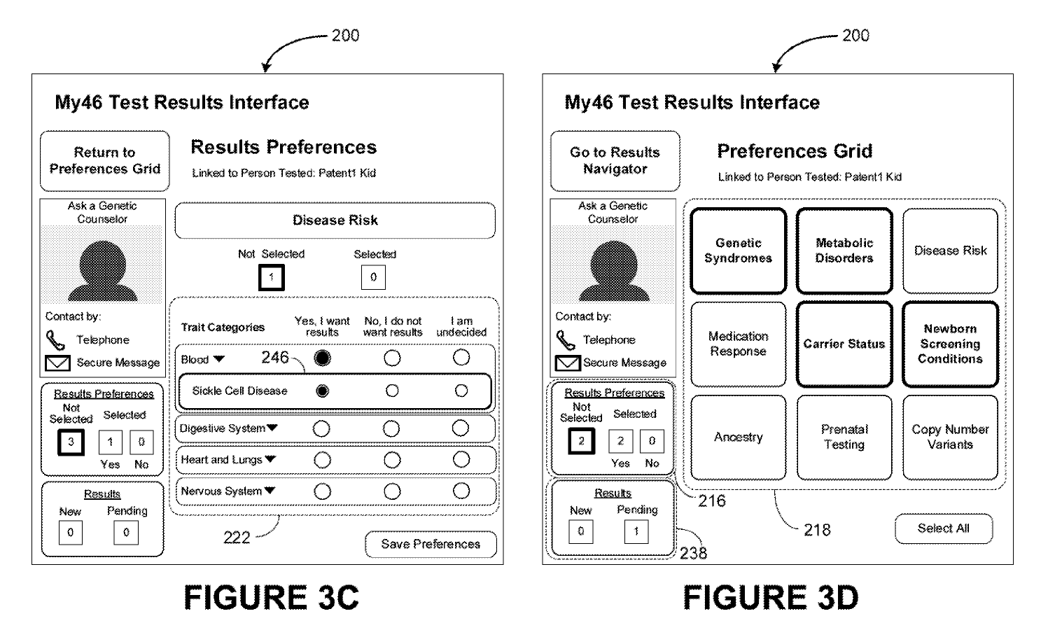

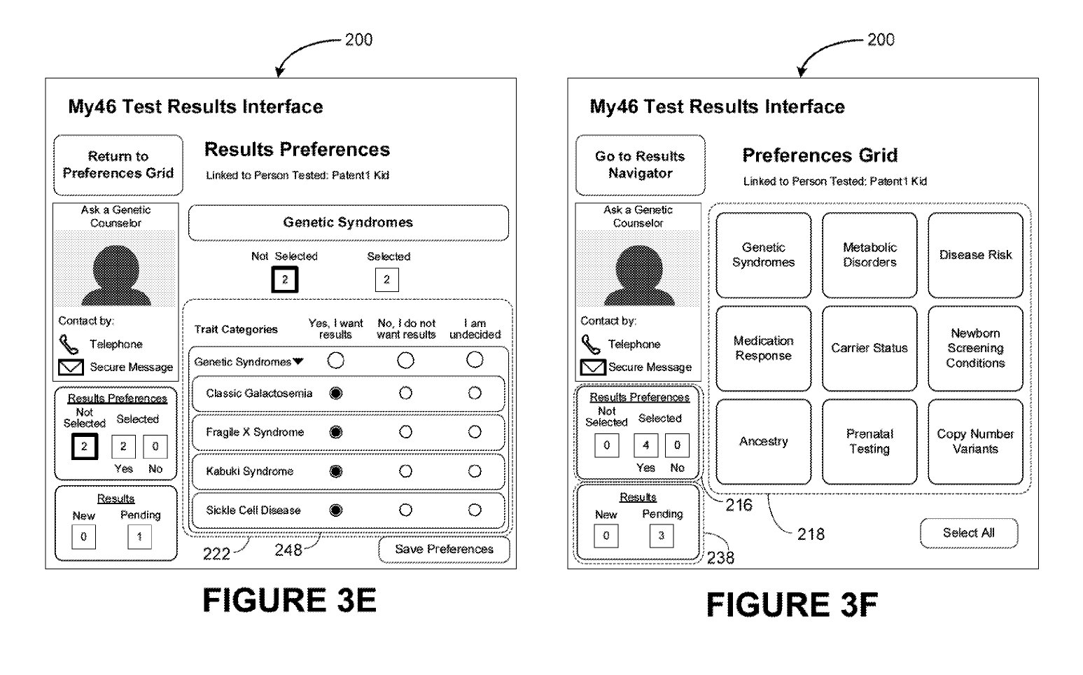

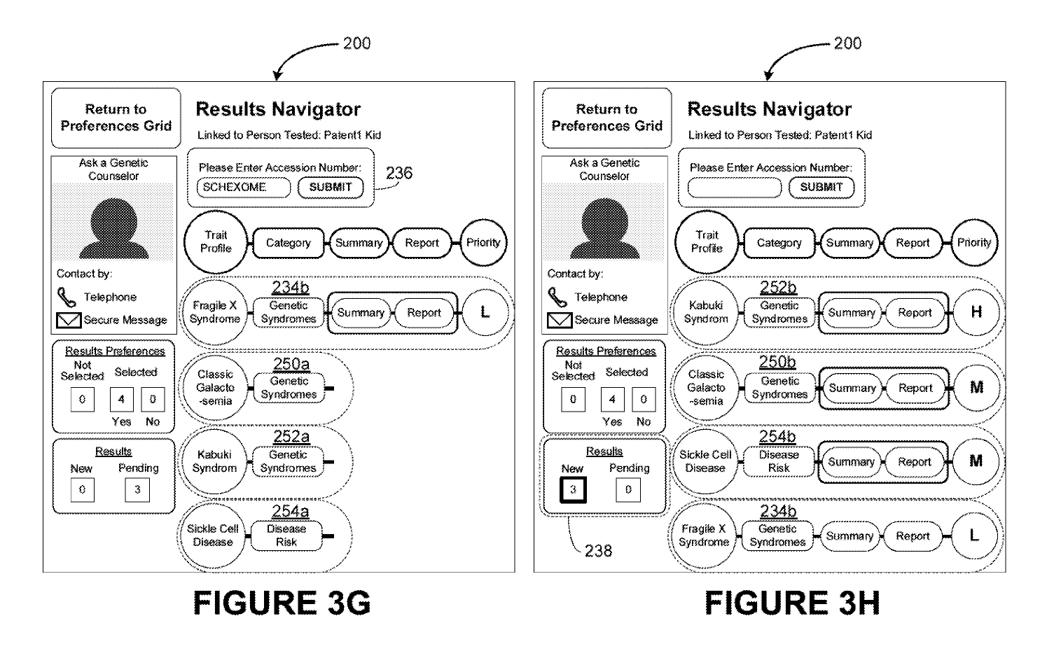

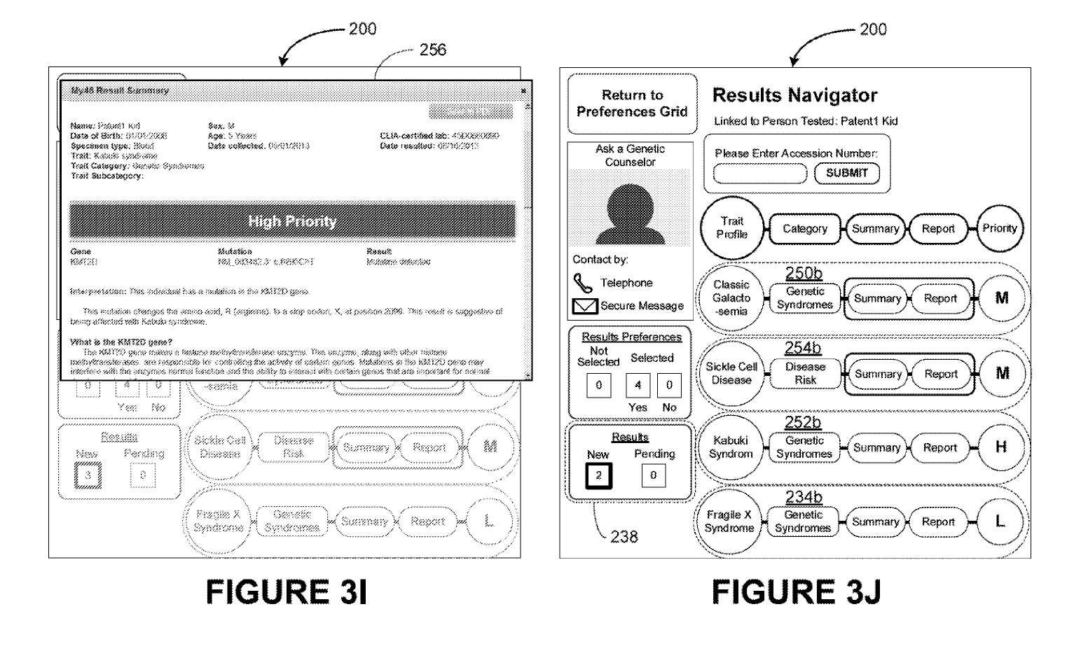

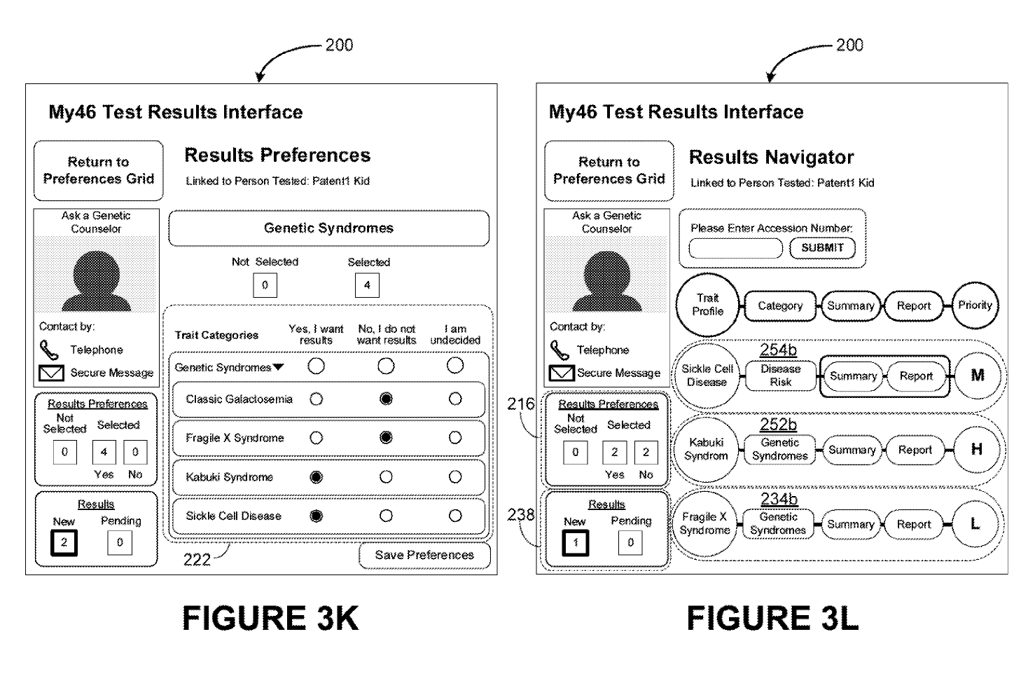

FIG. 3A shows the example interface 200 when the user accesses the test database again, after being informed that new test results are available. As shown, the Results Preference section 216 may indicate that one result has been selected, and three results have not been selected. In this case, the one result that has been selected may be the previously selected “fragile x syndrome” test result. In this case, the “Set Preferences” icon on the interface 200 may be selected to proceed with setting result-viewing preferences for the three non-selected test results.

Because the user has previously accessed the test database and may have provided subject data as discussed above in connection to blocks 102-106, the interface 200 as shown in FIG. 3B may proceed directly to cause at least one visual indication corresponding to the identified at least one respective test result to be provided on the display, as discussed above in connection to block 108. As previously shown in FIG. 2F, the interface 200 of FIG. 3B may cause the at least one visual indication corresponding to the at least one determined result category to be provided on a display by providing the result categories grid 218. In this case, the three non-selected test results may fall under five different categories visually represented by a highlighted “Genetic Syndromes” tile, a highlighted “Metabolic Disorders” tile, a highlighted “Disease Risk” tile, a highlighted “Carrier Status” tile, and a highlighted “Newborn Screening Conditions” tile. From the result categories grid 218, the “Disease Risk” tile may be selected for further selection of test results to be viewed.

The interface 200 of FIG. 3C provides the result-viewing selection box 222 including selectable options 246 corresponding to a “sickle cell disease” test result so as to, as discussed above in connection to block 110 of the method 100, receive selection data indicating a selection of one or more of the identified at least one respective test result, which in this case is the “sickle cell disease” test result. As shown, a selection of “Yes, I want results” may be selected from the selection options 246 corresponding to the test result for “sickle cell disease,” and a selection of the “Save preferences” icon may cause the selection to be stored, as also described above in connection to block 110.

Proceeding to FIG. 3D accordingly, the Results Preferences section 216 of the interface 200 indicates that two results have been selected, and that two results have not been selected, and the Results section 238 indicates that one test result is pending. In this case, because there are test results that have not yet been selected, the interface 200 may be configured to cause the at least one visual indication corresponding to the at least one determined result category to be provided on a display as discussed above in connection to block 108 by once again providing the result categories grid 218. In this case, the result categories grid 218 may show only four highlighted tiles—the “Genetic Syndromes” tile, the “Metabolic Disorders” tile, the “Carrier Status” tile, and the “Newborn Screening Conditions” tile, indicating that the two non-selected test results fall under the four categories visually represented by highlighted tiles.

From the result categories grid 218, the “Genetic Symptoms” tile may be selected for further selection of test results to be viewed, and the interface 200 of FIG. 2E may provide the result-viewing selection box 222 including selectable options 248 corresponding to test results for “classic galactosemia,” “fragile x syndrome,” “kabuki syndrome,” and “sickle cell disease” so as to receive selection data indicating a selection of one or more of the identified at least one respective test result as discussed above in connection to block 110. Because result viewing preferences for “sickle cell disease” and “fragile x syndrome” have been previously provided and stored, the selectable options 248 in the result-viewing selection box 222 may initially show the previously provided selections for “sickle cell disease” and “fragile x syndrome,” while no selections are shown for the selectable options 248 in the result-viewing selection box 222 for “classic galactosemia” and “kabuki syndrome.” Within the selection box 222, the selection options 248 for each of the four test results may be selected, including the two results for which selections have previously been made. As shown, a selection of “Yes, I want results” may be selected from the selection options 248 corresponding to each of the four test results, and a selection of the “Save preferences” icon may cause the selections to be stored, also similar to that described above in connection to block 110.

Proceeding to FIG. 3F, the Results Preferences section 216 of the interface 200 indicates that four results have been selected, and no results remain non-selected, and the Results section 238 indicates that three test results are pending. As shown, no category tile in the category grid 218 is highlighted, indicating that none of the visually represented categories include non-selected test results.

From the interface 200 shown in FIG. 3F, a selection of the “Go to Results Navigator” icon may cause the interface 200 as shown in FIG. 3G to provide partial representations 250a, 252a, and 254a corresponding to test results for “classic galactosemia,” “kabuki syndrome,” and “sickle cell disease,” respectively, similar to that described above in connection to FIG. 21. In this case, the full visual representation 234b for the previously selected and displayed “fragile x syndrome” test result may also be provided on the interface 200 because “fragile x syndrome” remained selected on the interface 200 of FIG. 3E. As discussed above in connection to FIG. 21 and block 112, the interface 200 as shown in FIG. 3G may provide the visual indication of the prompt 236 to be provided on the display so as to receive access data indicating a result-access credential for accessing the selected one or more of the identified at least one respective test result. In this example, the prompt 236 may request access data indicating the result-access credential to access the selected new results, which in this case are test results for “classic galactosemia,” “kabuki syndrome,” and “sickle cell disease.” As shown in FIG. 3G, access data indicating the result-access credential for these new test results in the form of a textual access code may be provided to the prompt 236.

In response to receiving and matching the access data, the interface 200 of FIG. 3H may cause a visual indication of the selected one or more of the identified at least one respective test result to be provided on the display as discussed above in connection to block 114 by providing full visual indications 250b, 252b, and 254b corresponding to test results for “classic galactosemia,” “kabuki syndrome,” and “sickle cell disease,” respectively, in addition to the full visual indication 234b corresponding to test results for “fragile x syndrome.” As shown, each of the full visual indications 250b, 252b, and 254b includes selectable “Summary” and “Report” icons for viewing a summary and a report on the selected one or more of the identified at least one respective test result, respectively. Also as shown in FIG. 3H, the Results section 238 has been updated to indicate that three new results are available, and that no test results are pending.

As shown, the “Summary” and “Report” icons for “classic galactosemia,” “kabuki syndrome,” and “sickle cell disease” are encircled by boxes indicating that the summary and report corresponding to each of these test results have not yet been displayed. Referring back to the method 100 of FIG. 1, block 114 may in this instance further involve determining that the visual indication of the selected one or more of the identified at least one respective test result was not previously displayed before causing the visual indication of the selected one or more of the identified at least one respective test result to be provided on the display. Accordingly, the at least one visual indication corresponding to the identified at least one respective test result, when provided, may indicate that the visual indication of the selected one or more of the identified at least one respective test result was not previously displayed. In this case, the box encircling the “Summary” and “Report” icons may indicate that the corresponding results were not previously displayed.

On the other hand, the “Summary” and “Report” icons for “fragile x syndrome,” which have been previously displayed as shown in FIG. 2K and 2L, are not encircled by a box, indicating that the summary and report corresponding to “fragile x syndrome” was previously displayed. Referring back to the method 100 of FIG. 1, block 114 in this instance may further involve determining that the visual indication of the selected one or more of the identified at least one respective test result was previously displayed before causing the visual indication of the selected one or more of the identified at least one respective test result to be provided on the display. Accordingly, the at least one visual indication corresponding to the identified at least one respective test result, when provided, may indicate that the visual indication of the selected one or more of the identified at least one respective test result was previously displayed. In this case, the absence of a box encircling the “Summary” and “Report” icons may indicate that the corresponding results, in this case that of “fragile x syndrome” was previously displayed.

As was the case with the full visual indication 234b, the full visual indications 250b, 252b, and 254b also include respective importance indicator indicating inferred degrees of impact of the corresponding test results on the well-being of the particular subject. In this case, the inferred degree of impact of the test result for “kabuki syndrome” is high, and the inferred degrees of impact of the test results for “classic galactosemia” and “sickle cell disease” are medium. Due to the high inferred degree of impact of the test result for “kabuki syndrome,” the “Summary” icon of the full visual indication 252b corresponding to the test result for “kabuki syndrome” may be selected. As shown in FIG. 31, a summary 256 of the test result for “kabuki syndrome” as applicable to the particular subject may be provided by the interface 200.

Subsequent to displaying the summary 256 in FIG. 31, the interface 200 as shown in FIG. 3J may provide full visual indications 234b, 250b, 252b, and 254b corresponding to test results for “classic galactosemia,” “sickle cell disease,” “kabuki syndrome,” and “fragile x syndrome” as previously shown in FIG. 3H. In this case however, because the summary 256 for the “kabuki syndrome” test result has already been displayed, the “Summary” and “Report” icons of the full visual indication 252b corresponding to the “kabuki syndrome” test result may no longer be encircled by a box, indicating that summary and/or report corresponding to the “kabuki syndrome” test result was previously displayed. Also shown in FIG. 3J is the Results section 238 updated to indicate that only two new results are now available.

In some scenarios, a user accessing the test database may have previously selected a group of test results to be displayed before changing his/her mind and subsequently selecting a different group of test results to be displayed. In other words, after receiving selection data and storing in the test database the selection-preference data, updated selection data indicating an updated selection of one or more of the identified at least one respective test result may be received via an updated selection of one or more of the at least one visual indication corresponding to the identified at least one test result, similar to that discussed above in connection to block 110.

Before receiving the updated selection data, however, the interface 200 of FIG. 3K may cause at least one visual indication corresponding to the identified at least one respective test result to be provided on the display as discussed above in connection to block 108 by providing the result-viewing selection box 222 as discussed previously. The result-view selection box 222 may be provided in response to the user selecting a “Return to Preferences Grid” icon of the interface 200 shown in FIG. 3J, and subsequently selecting the “Genetic Syndromes” tile from the result categories grid 218. As shown in FIG. 3K, updated selections may have been made to the selectable options indicating a selection of “No, I do not want results” for the “classic galactosemia” and “fragile x syndrome” test results, while the selection of “Yes, I want results” for the “kabuki syndrome” and “sickle cell disease” test results remains unchanged.

Once these selections have been made, the “Save preferences” icon may be selected to cause the updated selection-preference data that indicates the updated selection of the one or more of the identified at least one respective test result may be stored in the test database similar to that described above in connection to block 110. In one case, the updated selection-preference data may override the previously stored selection-preference data.

Upon receiving the updated selection data, if access data indicating a result-access credential for accessing any one of the updated selection of one or more of the identified at least one respective test result was not already received from the user, the user may be prompted to provide the necessary access data, as discussed above in connection to block 112. Upon entering the access data, or in the case access data for accessing the updated selection of one or more of the identified at least one respective test result was previously provided, a visual indication of the updated selection of one or more of the identified at least one respective test result may be provided on the display, as discussed above in connection to block 114.

As shown, the interface 200 of FIG. 3L provides a visual indication of the selected one or more of the identified at least one respective test result to be provided on the display by providing the full visual indications 250b, 252b, and 234b corresponding to test results for “sickle cell disease,” “kabuki syndrome,” and “fragile x syndrome,” respectively. In this case, because the stored updated selection-preference data indicates the selection of only test results for “kabuki syndrome” and “sickle cell disease,” the full visual indication 254b that corresponds to the “classic galactosemia” test result is not shown.

On the other hand, the full visual indication 234b corresponding to the “fragile x syndrome” test result may still be shown because the summary 242 and report 244 for “fragile x syndrome” has already been displayed as shown in FIGS. 2K-L. In some embodiments, the full visual indication 234b corresponding to the “fragile x syndrome” test result may not be shown if the updated selection-preference data did not indicate a selection of test results for “fragile x syndrome,” whether or not the summary 242 or report 244 has previously been displayed. Other examples may also be possible. The interface 200 of FIG. 3L also includes the Results Preferences section 216 indicating that two test results are selected and two test results are not selected. As shown, the Results section 238 may be updated to indicate that one new result out of the two selected, and in this case, three displayed test results are now available.

As technology advances and further discoveries are made in the sequencing of the human genome and exome, additional information may be determined based on data acquired from previous tests. For instance, the raw genome or exome sequence data from a previous test may be re-processed and re-annotated to identify new, previously unavailable biological information represented within the genome or exome sequence data, producing updated annotated variant data.

In connection to method 100 of FIG. 1, updated test-result data indicating an updated result of the identified at least one respective test result may be received. As suggested above, the updated test-result data comprises updated annotated variant data generated based on the test performed on the particular subject. In this case, maintaining the test database as discussed in connection with block 102 of the method 100 may involve storing the updated test-result data in the test database.

In one example, an updated result-access credential for accessing the updated result of the identified at least one respective test result may be generated in response to receiving from the laboratory updated test-result data at the test database. In another example, the same result-access credential generated for the original identified at least one respective test result may also be used to access the updated test result. Similarly, in one case, a new selection-preference data may be determined and stored for the updated result, while in another case the same selection-preference data stored for the original identified at least one respective test results may be applied to the updated result. Other examples may also be possible.

In some examples, because the updated result of the identified at least one respective test result may effectively be a new result that has not previously been displayed, the visual indication of the selected one or more of the identified at least one respective test result to be provided on the display may indicate that the updated result of the at least one test result is available. Referring back to FIG. 3L for example, if an updated result corresponding to the “kabuki syndrome” test result is available, a box encircling the “Summary” and “Report” icons in the full visual indication 252b corresponding to the “kabuki syndrome” test result may re-appear. In some cases, to distinguish an updated result from a new result, the visual indication indicating the availability of the updated result may be different from the visual indication indicating a new result. For instance, the box encircling the “Summary” and “Report” icons in the full visual indication 252b corresponding to the “kabuki syndrome” test result may be of a different color depending on whether the available, not previously displayed test result is an updated test result, or a test result from a new test. Other examples may also be possible.

As previously indicated, while the example embodiments described herein may relate particularly to returning patient genome or exome sequencing results, one having ordinary skill in the art will appreciate that the systems and methods disclosed in relation to the example embodiments may be implemented for a variety of different applications. The variety of different applications may include the return of other patient health and medical test results, or general academic or certification test results.

As indicated above, in some embodiments, the disclosed methods may be implemented by computer program instructions encoded on a physical and/or non-transitory computer-readable storage media in a machine-readable format, or on other physical and/or non-transitory media or articles of manufacture. FIG. 4 is a schematic illustrating a conceptual partial view of an example computer program product that includes a computer program for executing a computer process on a computing device, arranged according to at least some embodiments presented herein.

In one embodiment, the example computer program product 400 may be provided using a signal bearing medium 402. The signal bearing medium 402 may include one or more programming instructions 404 that, when executed by one or more processors may provide functionality or portions of the functionality described with respect to FIG. 1. In some examples, the signal bearing medium 402 may encompass a physical and/or non-transitory computer-readable medium 406, such as, but not limited to, a hard disk drive, a Compact Disc (CD), a Digital Video Disk (DVD), a digital tape, memory, etc. In some implementations, the signal bearing medium 402 may encompass a computer recordable medium 408, such as, but not limited to, memory, read/write (R/W) CDs, R/W DVDs, etc. In some implementations, the signal bearing medium 402 may encompass a communications medium 410, such as, but not limited to, a digital and/or an analog communication medium (e.g., a fiber optic cable, a waveguide, a wired communications link, a wireless communication link, etc.). Thus, for example, the signal bearing medium 402 may be conveyed by a wireless form of the communications medium 410.

The one or more programming instructions 404 may be, for example, computer executable and/or logic implemented instructions. In some examples, a processing unit of a computing device may be configured to provide various operations, functions, or actions in response to the programming instructions 404 conveyed to the processing unit by one or more of the computer readable medium 406, the computer recordable medium 408, and/or the communications medium 410.

The physical and/or non-transitory computer readable medium could also be distributed among multiple data storage elements, which could be remotely located from each other. The computing device that executes some or all of the stored instructions could be a computing device such as any of those described above. Alternatively, the computing device that executes some or all of the stored instructions could be another computing device, such as a server.

FIG. 5 shows a simplified block diagram of an example communication network in which the method 100 described above can be implemented. It should be understood that this and other arrangements described herein are set forth only as examples. Those skilled in the art will appreciate that other arrangements and elements (e.g., machines, interfaces, functions, orders, and groupings of functions, etc.) can be used instead and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. And various functions described herein may be carried out by a processor executing instructions stored in memory.

As shown in FIG. 5, example network 500 includes various network-access devices 502A-502D, public network 504 such as the Internet, and server 506. Note that additional entities not depicted in FIG. 5 could be present as well. As an example, there could be more network-access devices and more servers in communication with public network 504. Other network elements may be in communication with public network 504 as well. Also, there could be one or more devices and/or networks making up at least part of one or more of the communication links depicted in FIG. 5. As an example, there could be one or more routers, switches, or other devices or networks on the communication links between network-access devices 502A-502D, public network 504, and/or server 506.

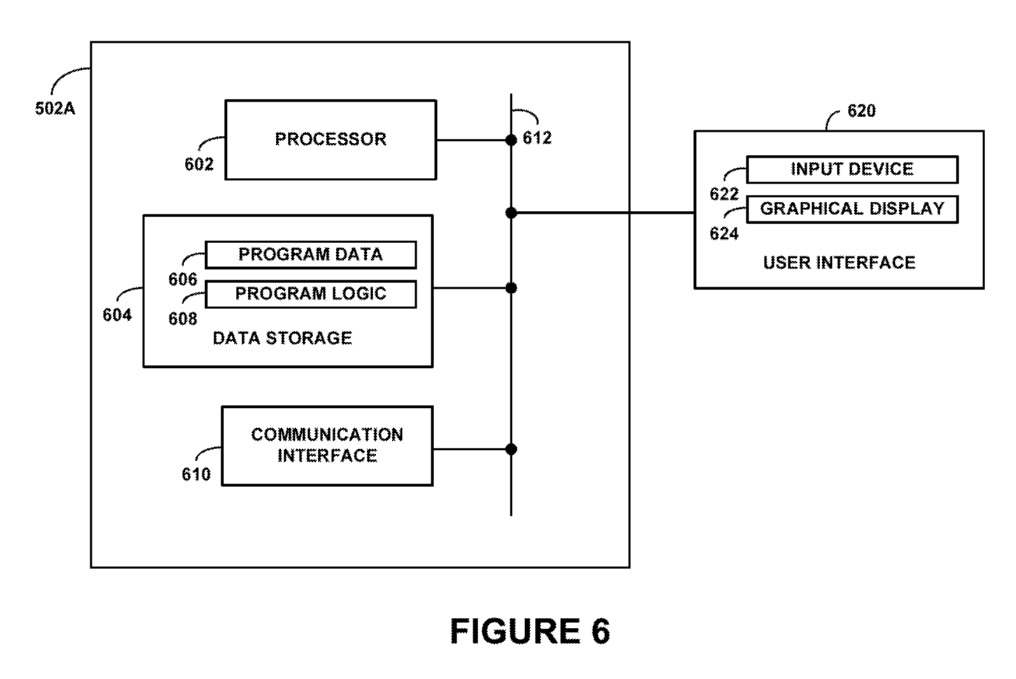

Each of network-access devices 502A-502D may be any network-access device arranged to carry out the network-access device functions described herein. As such each of network-access devices 502A-502D, including network-access device 502A as shown in FIG. 6, may include processor 602, data storage 604, and communication interface 610, all linked together via system bus, network, or other connection mechanism 612.

Processor 602 may include one or more general purpose microprocessors and/or one or more dedicated signal processors and may be integrated in whole or in part with communication interface 610. Data storage 604 may include memory and/or other storage components, such as optical, magnetic, organic or other memory disc storage, which can be volatile and/or non-volatile, internal and/or external, and integrated in whole or in part with processor 602. Data storage 604 may be arranged to contain (i) program data 606 and (ii) program logic 608. Although these components are described herein as separate data storage elements, the elements could just as well be physically integrated together or distributed in various other ways. For example, program data 606 may be maintained in data storage 604 separate from program logic 608, for easy updating and reference by program logic 608.

Communication interface 610 typically functions to communicatively couple network-access device 502A to networks, such as public network 504. As such, communication interface 610 may include a wired (e.g., Ethernet) and/or wireless (e.g., Wi-Fi) packet-data interface, for communicating with other devices, entities, and/or networks. Network-access device 502A may also include multiple interfaces 610, such as one through which network-access device 502A sends communication, and one through which network-access device 502A receives communication.

Network-access device 502A may also include, or may be otherwise communicatively coupled to, user interface 620. User interface 620 may include input device 622 including, for example, buttons, a touch screen, a microphone, and/or any other elements for receiving inputs. User interface 620 may also include one or more elements for communicating outputs, for example, one or more graphical displays 624 and/or a speaker. In operation, user interface 620 may be configured to display a graphical user interface (GUI) via graphical display 624 and may also be configured to receive inputs, via input device 622, corresponding to use of such a GUI.

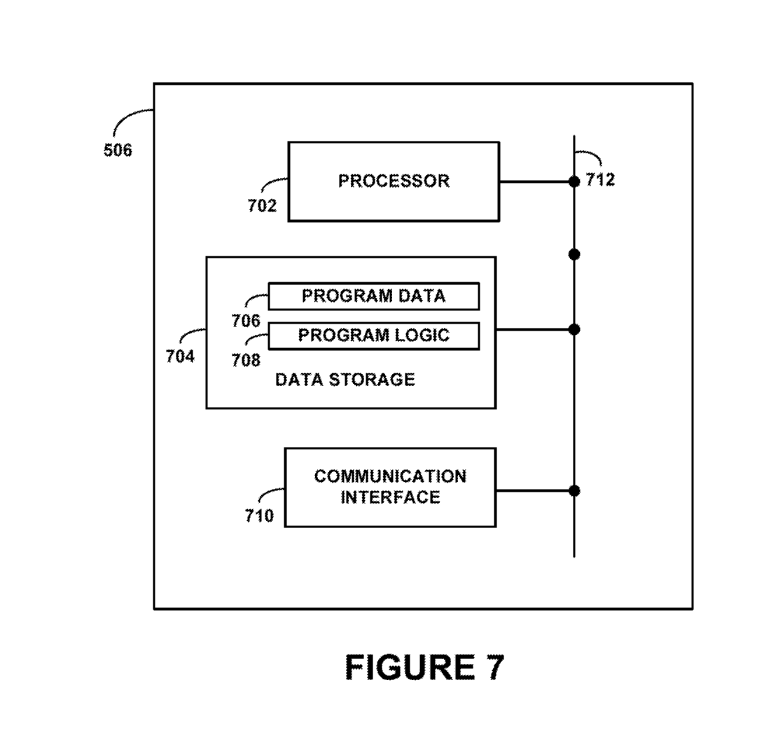

Server 506 may be any network server or other computing system arranged to carry out the server functions described herein including, but not limited to, those functions described with respect to FIG. 1 described above. As such, as shown in FIG. 7, server 506 may include processor 702, data storage 704 including program data 706 and program logic 708, and communication interface 710, all linked together via system bus, network, or other connection mechanism 712. Processor 702, data storage 704, program data 706, program logic 708, and communication interface 710 may be configured and/or arranged similar to processor 702, data storage 704, program data 706, program logic 708, and communication interface 710, respectively, as described above with respect to network-access device 502A.

Data storage 704 may contain information used by server 506 in operation. For example, date storage 704 may include instructions executable by the processor for carrying out the server functions described herein including, but not limited to, those functions described above with respect to FIG. 1. As another example, data storage 704 may contain various design logic and/or design data used for determining a test result, such as the logic and data described above with respect to FIG. 1. Generally, data storage 704 may contain information used by server 506 to provide an e-commerce storefront that is accessible by various network-access devices, such as network-access device 502A, over public network 504.

Returning to FIG. 5, public network 504 may include one or more wide area networks, one or more local area networks, one or more public networks such as the Internet, one or more private networks, one or more wired networks, one or more wireless networks, and/or one or more networks of any other variety. Devices in communication with public network 504 (including, but not limited to, network-access devices 502A-502D and server 506) may exchange data using a packet-switched protocol such as IP, and may be identified by an address such as an IP address.

While various aspects and embodiments have been disclosed herein, it should be understood that the embodiments are example embodiments and are described in connection to just some of many possible applications. Accordingly, it should also be understood that other aspects and embodiments are also possible. The various aspects and embodiments disclosed herein are for purposes of illustration and are not intended to be limiting, with the true scope and spirit being indicated by the following claims.

1. A computer implemented method comprising:
maintaining a test database comprising data that indicates (a) one or more subjects and (b) a plurality of test results, wherein each subject is associated with one or more respective test result from the plurality of test results;
receiving subject data that identifies a particular subject in the test database;
identifying at least one respective test result associated with the particular subject;
causing at least one visual indication corresponding to the identified at least one respective test result to be provided on a display;
receiving selection data, wherein the selection data indicates a selection of one or more of the identified at least one respective test result via a selection of one or more of the at least one visual indication corresponding to the identified at least one test result;
receiving access data, wherein the access data indicates a result-access credential for accessing the selected one or more of the identified at least one respective test result; and
in response to receiving the access data, causing a visual indication of the selected one or more of the identified at least one respective test result to be provided on the display.

2. The method of claim 1, further comprising:
in response to receiving the selection data, determining access requirements for the selected one or more of the identified at least one respective test result; and
causing a visual indication of a prompt to be provided on the display, wherein the prompt requests the access data indicating the result-access credential to access the selected one or more of the identified at least one respective test result.

3. The methods of claim 1, further comprising:
before receiving the subject data, receiving user-identification data that indicates a database-access credential for accessing the test database, wherein the user-identification data is associated with the subject data.

4. The method of claim 3, wherein identifying at least one respective test result associated with the particular subject comprises:
identifying the at least one respective test result based on at least the user-identification data.

5. The method of claims 3, further comprising:
storing in the test database selection-preference data that indicates the selection of one or more of the identified at least one respective test result, wherein the selection-preference data is associated with the user-identification data.

6. The method of claim 5, further comprising:
after storing in the test database the selection-preference data, receiving updated selection data, wherein the updated selection data indicates an updated selection of one or more of the identified at least one respective test result via an updated selection of one or more of the at least one visual indication corresponding to the identified at least one test result; and
storing in the test database updated selection-preference data that indicates the updated selection of the one or more of the identified at least one respective test result.

7. The method of claim 1, further comprising:
before causing a visual indication of the selected one or more of the identified at least one respective test result to be provided on the display, determining that the visual indication of the selected one or more of the identified at least one respective test result was not previously displayed,
wherein the at least one visual indication corresponding to the identified at least one respective test result indicates that the visual indication of the selected one or more of the identified at least one respective test result was not previously displayed.

8. The method of any one of claims 1, further comprising:
before causing a visual indication of the selected one or more of the identified at least one respective test result to be provided on the display, determining that the visual indication of the selected one or more of the identified at least one respective test result was previously displayed,
wherein the at least one visual indication corresponding to the identified at least one respective test result indicates that the visual indication of the selected one or more of the identified at least one respective test result was previously displayed.

9. The method of claim 1, wherein the at least one visual indication corresponding to the identified at least one respective test result indicates an inferred degree of impact of the identified at least one respective test result on a well-being of the particular subject.

10. The method of claim 1, further comprising:
before causing the at least one visual indication corresponding to the identified at least one respective test result to be provided on a display, determining at least one result category associated with the identified at least one respective test result;
causing at least one visual indication corresponding to the at least one determined result category to be provided on the display; and
receiving category-selection data, wherein the category selection data indicates a selection of one or more of the at least one determined result category via a selection of one or more of the at least one visual indication corresponding to the at least one determined result category, and wherein the selected one or more of the at least one determined results category is associated with the identified at least one respective test result.

11. The method of claim 1, further comprising:
before receiving the subject data, receiving test-result data indicating at least one of the one or more respective test result associated with the particular subject, wherein the received test-result data comprises (a) an identification of the particular subject and (b) annotated variant data generated based on a test performed on the particular subject; and
generating the result-access credential for accessing the at least one test result based on the identification of the particular subject,
wherein maintaining the test database comprises storing the received test-result data in the test database.

12. The method of claim 11, further comprising:
before causing the visual indication of the selected one or more of the identified at least one respective test result to be provided on the display, selecting the visual indication of the selected one or more of the identified at least one respective test result based on the annotated variant data in the test result data.

13. The method of claim 1, further comprising:
before identifying at least one respective test result associated with the particular subject, receiving updated test-result data indicating an updated result of the identified at least one respective test result, wherein the updated test-result data comprises updated annotated variant data generated based on the test performed on the particular subject,
wherein maintaining the test database comprises storing the updated test-result data in the test database.

14. The method of claim 13, further comprising:
in response to receiving updated test-result data, generating an updated result-access credential for accessing the updated result of the identified at least one respective test result.

15. The method of claim 13, wherein the visual indication of the selected one or more of the identified at least one respective test result to be provided on the display indicates that the updated result of the at least one test result is available.

16. The method of claim 1, wherein the one or more respective test result associated with the particular subject indicates one or more genetic conditions of the particular subject.

17. The method of claim 16, wherein the visual indication of the selected one or more of the identified at least one respective test result indicates one or more of the following: (a) a description of the genetic condition, (b) symptoms of the genetic condition, (c) health risks relating to the genetic condition, and (d) available options for managing the genetic condition.

18. A system comprising:
a processor;
a physical computer readable medium; and
program instructions stored on the physical computer readable medium and executable by the processor to:
maintain a test database comprising data that indicates (a) one or more subjects and (b) a plurality of test results, wherein each subject is associated with one or more respective test result from the plurality of test results;
receive subject data that identifies a particular subject in the test database;
identify at least one respective test result associated with the particular subject;
cause at least one visual indication corresponding to the identified at least one respective test result to be provided on a display;
receive selection data, wherein the selection data indicates a selection of one or more of the identified at least one respective test result via a selection of one or more of the at least one visual indication corresponding to the identified at least one test result;
receive access data, wherein the access data indicates a result-access credential for accessing the selected one or more of the identified at least one respective test result; and
in response to receiving the access data, cause a visual indication of the selected one or more of the identified at least one respective test result to be provided on the display.

19. The system of claim 18, the system further comprising program instructions stored on the physical computer readable medium and executable by the processor to:
before causing the at least one visual indication corresponding to the identified at least one respective test result to be provided on a display, determine at least one result category associated with the identified at least one respective test result;
cause at least one visual indication corresponding to the at least one determined result category to be provided on the display; and
receive category-selection data, wherein the category selection data indicates a selection of one or more of the at least one determined result category via a selection of one or more of the at least one visual indication corresponding to the at least one determined result category, and wherein the selected one or more of the at least one determined results category is associated with the identified at least one respective test result.

20. A physical computer readable medium having instructions stored thereon, the instructions comprising:
instructions for maintaining a test database comprising data that indicates (a) one or more subjects and (b) a plurality of test results, wherein each subject is associated with one or more respective test result from the plurality of test results;
instructions for receiving subject data that identifies a particular subject in the test database;
instructions for identifying at least one respective test result associated with the particular subject;
instructions for causing at least one visual indication corresponding to the identified at least one respective test result to be provided on a display;
instructions for receiving selection data, wherein the selection data indicates a selection of one or more of the identified at least one respective test result via a selection of one or more of the at least one visual indication corresponding to the identified at least one test result;
instructions for receiving access data, wherein the access data indicates a result-access credential for accessing the selected one or more of the identified at least one respective test result; and
instructions for causing a visual indication of the selected one or more of the identified at least one respective test result to be provided on the display in response to receiving the access data.

21. (canceled)
